(19) United States
(12) Patent Application Publication
(10) Pub. No.: US 2023/0323109 A1
(43) Pub. Date: Oct. 12, 2023

(54) WEAR-RESISTANT POLYESTER MATERIAL

(71) Applicant: NAN YA PLASTICS CORPORATION, TAIPEI (TW)

(72) Inventors: Te-Chao Liao, TAIPEI (TW); Chun-Che Tsao, TAIPEI (TW); Wen-Jui Cheng, TAIPEI (TW); Yueh-Shin Liu, TAIPEI (TW)

(73) Assignee: NAN YA PLASTICS CORPORATION, TAIPEI (TW)

(21) Appl. No.: 17/950,081

(22) Filed: Sep. 21, 2022

(30) Foreign Application Priority Data
Apr. 12, 2022 (TW) 111113817

(51) Int. Cl. C08L 67/02; C08K 3/36; C08K 3/26; C08K 3/34; C08K 5/098

(52) U.S. Cl. CPC C08L 67/02; C08K 3/36; C08K 3/26; C08K 3/346; C08K 5/098; C08K 2003/265

(57) ABSTRACT

The disclosure provides a wear-resistant polyester material, which includes a polyethylene terephthalate (PET) resin, a nucleating agent, a lubricant, and an antioxidant.

### CROSS-REFERENCE TO RELATED APPLICATION

This application claims the priority benefit of Taiwan application serial no. 111113817, filed on Apr. 12, 2022. The entirety of the above-mentioned patent application is hereby incorporated by reference herein and made a part of this specification.

### BACKGROUND

### Technical Field

The disclosure relates to a polyester material, and particularly relates to a wear-resistant polyester material.

### Description of Related Art

The market is gradually orientated toward the trend of circular economy and plastic recycling. Under such a market trend, use of one single material for products and introduction of recycled materials are important goals for future development. The introduction of recycled materials means to introduce environmentally friendly recycled materials on the premise that mechanical properties and processability are not affected, which helps to achieve the goal of reducing plastics and saving energy globally. The use of one single material means to simplify the material used in making products so that the products can be directly recycled when they reach the service life, which avoids poor recyclability caused by the mixing of different materials.

Taking clothes and backpacks as an example, the fabrics of clothes and backpacks are usually made of a polyester material (for example, polyethylene terephthalate (PET)), but the buckles and zippers are usually made of a polyoxymethylene (POM) material or a nylon material. After these products are discarded, they can only be incinerated or manually dismantled in order to be recycled. Products such as curtains face the same issue.

In order to use one single material, the buckles or peripheral accessories made of a POM material or a nylon material, for example, can be made with a PET polyester material instead. However, the existing PET material has a slow crystallization rate, insufficient heat resistance, and a large surface friction coefficient and may not be easily used for injection of products made of POM and nylon, resulting in limited application.

### SUMMARY

The disclosure provides a wear-resistant polyester material, which has a fast crystallization rate, a small surface friction coefficient, and improved wear resistance.

The wear-resistant polyester material according to the disclosure includes a polyethylene terephthalate (PET) resin, a nucleating agent, a lubricant, and an antioxidant.

In an embodiment of the disclosure, the PET resin is added in an amount of 99.35% by weight to 95% by weight, the nucleating agent is added in an amount of 0.5% by weight to 3% by weight, the lubricant is added in an amount of 0.05% by weight to 1% by weight, and the antioxidant is added in an amount of 0.1% by weight to 1% by weight based on a total weight of the wear-resistant polyester material.

In an embodiment of the disclosure, the nucleating agent is added in an amount of 1% by weight to 2% by weight based on a total weight of the wear-resistant polyester material, as the ideal addition ratio.

In an embodiment of the disclosure, the PET resin includes a virgin resin, a post consumer recycled (PCR) resin, or a combination thereof.

In an embodiment of the disclosure, the PET resin has an intrinsic viscosity (IV) of 0.58 to 0.92.

In an embodiment of the disclosure, the nucleating agent includes an organic nucleating agent, an inorganic nucleating agent, or a blend thereof.

In an embodiment of the disclosure, the organic nucleating agent includes organic sodium salts, and the organic sodium salts include sodium benzoate, sodium stearate, sodium salt of montanic acids, or sodium salt of ethylene-methyl methacrylate copolymer (EMAA-Na).

In an embodiment of the disclosure, the inorganic nucleating agent includes inorganic micro-nano powder, and the inorganic micro-nano powder includes talc, titanium dioxide, silicon dioxide, or calcium carbonate.

In an embodiment of the disclosure, the lubricant includes stearates, polyethylene wax, siloxane modifier, or a fluorine-based resin.

In an embodiment of the disclosure, the antioxidant includes a hindered phenolic antioxidant, a phenolic antioxidant, a mixed antioxidant, a phosphite-based antioxidant, a complex antioxidant, or a combination thereof.

Based on the above, the wear-resistant polyester material according to an embodiment of the disclosure is modified by introducing the nucleating agent, the lubricant, and the antioxidant into the PET resin. The nucleating agent increases the crystallization and solidification rate and effectively improves the shrinkage rate of the PET material. The lubricant reduces the surface friction coefficient of the PET material to improve the wear resistance of the product. The antioxidant improves the heat resistance and processability of the PET material. Accordingly, the slow crystallization rate and insufficient heat resistance of the existing PET material are effectively improved, and the surface friction coefficient of the PET material is reduced to improve the wear resistance so that the wear-resistant polyester material of the disclosure is applicable to injection molding of zippers, buckles, curtain parts, stationery, cases, and other products to achieve the goal of use of one single material.

### DETAILED DESCRIPTION OF DISCLOSED EMBODIMENTS

Hereinafter, embodiments of the disclosure will be described in detail. However, these embodiments are exemplary, and the disclosure is not limited thereto.

In this specification, a range represented by “one numerical value to another numerical value” is a general representation that avoids listing all the numerical values within the range. Accordingly, the recitation of a particular numerical range covers any numerical value within that numerical range as well as a smaller numerical range defined by any numerical value within that numerical range, as if the above-mentioned any numerical value and smaller numerical range are specified in this specification.

According to the disclosure, the wear-resistant polyester material includes a polyethylene terephthalate (PET) resin, a nucleating agent, a lubricant, and an antioxidant. Specifically, the wear-resistant polyester material is modified by introducing appropriate amounts of the nucleating agent, the lubricant, and the antioxidant into the PET resin. In some embodiments, compared to a unmodified PET polyester material, the modified PET polyester material (that is, the wear-resistant polyester material of the disclosure) has a faster crystallization and solidification rate, better heat resistance, a smaller surface friction coefficient, or better wear resistance. Therefore, the modified PET polyester material is applicable to injection molding of products such as zippers, buckles, curtain parts, stationery, or cases, but not limited thereto. Hereinafter, the above-mentioned various components will be described in detail.

### Polyethylene Terephthalate (PET) Resin

In this embodiment, the PET resin may include a virgin resin, a post consumer recycled resin (PCR resin), or a combination thereof. The sources of the PCR resin may include recycled resin from bottles, recycled resin from film materials, recycled resin from fabrics, industrially recycled environmentally friendly recycled polyester resin (such as release films), or other PET products, in order to realize the introduction of recycled materials, but not limited thereto.

Specifically, based on the total weight of the wear-resistant polyester material, the PET resin may be added in an amount of, for example, 99.35% by weight to 95% by weight, but not limited thereto. In an embodiment of the disclosure, the intrinsic viscosity (IV) of the PET resin used may be, for example, 0.58 to 0.92, preferably 0.76 to 0.88, but not limited thereto. When the intrinsic viscosity of the PET resin is less than 0.58, the impact strength of the PET resin may be too low, and as a result, the injection molded product may have insufficient strength and embrittlement. When the intrinsic viscosity of the PET resin is greater than 0.92, the viscosity of the PET resin may be too high, and the PET resin may not be suitable for injection molding.

### Nucleating Agent

In this embodiment, the nucleating agent may include an organic nucleating agent, an inorganic nucleating agent, or a blend thereof. The organic nucleating agent may include organic sodium salts, such as sodium benzoate, sodium stearate, sodium salt of montanic acids, or sodium salt of ethylene-methyl methacrylate copolymer (EMAA-Na), but not limited thereto. The inorganic nucleating agent may include inorganic micro-nano powder, such as talc, titanium dioxide, silicon dioxide, or calcium carbonate, but not limited thereto. The introduction of the nucleating agent increases the crystallization and solidification rate and effectively improves the shrinkage rate of the PET material, thereby improving the processability. In this embodiment, based on the total weight of the wear-resistant polyester material, the nucleating agent is added in an amount of, for example, 0.5% by weight to 3% by weight, preferably 1% by weight to 2% by weight, but not limited thereto. When the amount of the nucleating agent added is less than 0.5% by weight, the effect of increasing the crystallization and solidification rate of PET may not be significant. When the amount of the nucleating agent added is greater than 3% by weight, the increase of the nucleation rate may have reached the limit, and the excessive addition may increase the cost and embrittle the material. Further, when the amount of the nucleating agent added is 1% by weight to 2% by weight, the material has relatively balanced mechanical properties (impact strength) and crystallization rate.

### Lubricant

In this embodiment, the lubricant may include stearates (for example, zinc stearate, sodium stearate, calcium stearate, etc.), polyethylene wax, siloxane modifier (for example, siloxane), or a fluorine-based resin (for example, PEFE). The introduction of the lubricant reduces the surface friction coefficient of the PET material, thereby improving the wear resistance of the product. In this embodiment, based on the total weight of the wear-resistant polyester material, the lubricant is added in an amount of, for example, 0.05% by weight to 1% by weight, preferably 0.1% by weight to 0.3% by weight, but not limited thereto. When the amount of the lubricant added is less than 0.05% by weight, the effect of reducing the friction coefficient may be poor, and the effect of improving the wear resistance of PET may not be significant. When the amount of the lubricant added is more than 1% by weight, the material may have excessively high fluidity, and as a result, flashing is likely to occur during injection, and the conditions are difficult to control. Furthermore, excessive addition of the lubricant may also cause embrittlement of the material and reduce the impact strength.

### Antioxidant

In this embodiment, the antioxidant may include hindered phenolic antioxidants (for example, AO-1010, AO-1076, AO-1315, etc.), mixed antioxidants (for example, B225, B215, B220, B911, etc.), phosphite-based antioxidants (for example, AO-168, AO-618, TNPP, etc.), complex antioxidants, or a combination thereof. The antioxidant improves the heat resistance and processability of the material. In this embodiment, based on the total weight of the wear-resistant polyester material, the antioxidant is added in an amount of, for example, 0.1% by weight to 1% by weight, preferably 0.3% by weight to 0.5% by weight, but not limited thereto. When the amount of the antioxidant added is less than 0.1% by weight, the effect of improving the heat resistance of the PET material during high temperature processing is not significantly improved, and the material is prone to yellowing. When the amount of the antioxidant added is more than 1% by weight, the effect of improvement may have reached the limit, and excessive addition may lead to an increase in cost.

A process of modifying the wear-resistant polyester material of the disclosure includes the following steps. First, the PET resin, the nucleating agent, the antioxidant, and the lubricant are added into an extruder at a main feed temperature of 230° C. to 250° C. Next, the resin material is melted in a melting stage at a temperature of 260° C. to 280° C. of the screw, and is fully kneaded with the modifiers such as the nucleating agent, the antioxidant, and the lubricant. Then, at a vacuum temperature of 245° C. to 265° C., the water vapor and low molecular oligomers are removed in a vacuum and low pressure manner, thereby obtaining the wear-resistant polyester material of the disclosure.

Hereinafter, the above-mentioned wear-resistant polyester material of the disclosure will be described in detail with reference to experimental examples. However, the following experimental examples are not intended to limit the disclosure.

### Experimental Example

In order to prove that the wear-resistant polyester material according to the disclosure has excellent mechanical properties and thus has good wear resistance, the following experimental example was carried out.

### Test Sample

The test samples were a POM material, an unmodified PET material, and the wear-resistant polyester material (that is, modified PET material) according to an embodiment of the disclosure. The POM material was Poly M90. The unmodified PET material was produced by compounding. Please refer to the above description for the method of producing the wear-resistant polyester material, wherein the PET resin was 98.5% by weight, the nucleating agent was 1% by weight, the antioxidant was 0.3% by weight, and the lubricant was 0.2% by weight.

### Test Method

Impact strength: The test was performed according to ASTM D256 standard. The obtained value (kg-cm/cm) indicates the total energy that the test sample can withstand when it breaks. A greater value indicates that the test sample can withstand greater impact strength (or the resistance strength of the test sample).

Tensile strength: The test was performed according to ASTM D638 standard. The obtained value indicates the total energy that the test sample can withstand against tensile deformation. A greater value indicates that the test sample can withstand greater tensile strength.

Flexural strength: The test was performed according to ASTM D790 standard. The obtained value indicates the ability of the test sample to resist flexural deformation. A greater value indicates that the test sample can withstand greater flexural strength.

Flexural modulus: The test was performed according to ASTM D790 standard. The obtained value indicates the total energy that the test sample can withstand against flexural deformation. A greater value indicates that the test sample has greater rigidity.

Material cooling crystallization temperature (T_{hc} (° C.)): The test was performed according to ASTM D3418 standard. The obtained value indicates the initial temperature at which the material begins to crystallize. A greater value indicates that the material has a faster crystallization rate.

Surface hardness: It means the pencil hardness. Pencil hardness grades from soft to hard are 6B, 5B, 4B, 3B, 2B, B, HB, F, H, 2H, 3H, 4H, 5H, 6H, 7H, 8H, and 9H. The pencil hardness test was performed from soft to hard according to the hardness specification, and the load applied on the pencil was 500 grams. The first pencil hardness that leaves scratches is considered the test result.

Rockwell hardness: The test was performed according to ASTM D785 standard. It is an index to determine the hardness value based on the depth of indentation plastic deformation. A greater value indicates that the material has greater hardness.

Dynamic/Static friction coefficient: The test was performed according to ASTM D1894 standard. The friction coefficient indicates the ratio of the frictional force between two solid surfaces to the normal pressure. A greater friction coefficient indicates that an object receives greater resistance when it slides.

Heat distortion temperature: The test was performed according to ASTM D648 standard. The obtained value indicates the resistance of the test sample against heat distortion. A greater value indicates that the test sample has greater heat resistance.

Wear loss weight: H-22 wheel, load 1 kg, 2000 times. The initial weight of the sample was measured first, and then the H-22 wheel with a load of 1 kg was used to repeatedly roll on the sample for 2000 times to measure the remaining weight of the sample. The difference between the initial weight and the remaining weight is the wear loss weight of the sample. A smaller value indicates greater wear resistance.

### Result

As can be seen from the following Table 1, compared to the unmodified PET material, the wear-resistant polyester material of the disclosure has a faster crystallization rate by injection molding (the unmodified PET material needs to be cooled to about 186.7° C. to crystallize while the wear-resistant polyester material of the disclosure can be crystallized when cooled to about 208.7° C.), better heat resistance (the heat distortion temperature of the unmodified PET material is 68° C. while the heat distortion temperature of the wear-resistant polyester material of the disclosure is 76° C.), a smaller surface friction coefficient (the dynamic/static friction coefficient of the unmodified PET material is 0.48/0.40 while the dynamic/static friction coefficient of the wear-resistant polyester material of the disclosure is 0.40/0.34), better wear resistance (the wear loss weight of the unmodified PET material is 381.7 mg while the wear loss weight of the wear-resistant polyester material of the disclosure is 298.6 mg), and good mechanical properties.

TABLE 1

| | | | | Wear- |
|---|---|---|---|---|
| | | | Unmodified | resistant |
| | | POM | PET | polyester |
| | | material | material | material |
| Mechanical | Impact strength | 4.9 | 3.4 | 3.6 |
| properties | (kg-cm/cm) | | | |
| | Tensile | 63.0 | 57.2 | 63.8 |
| | strength | | | |
| | (MPa) | | | |
| | Flexural | 88.0 | 88.1 | 96.2 |
| | strength | | | |
| | (MPa) | | | |
| | Flexural | 2550 | 2400 | 2650 |
| | modulus | | | |
| | (MPa) | | | |

| | | | |
|---|---|---|---|
| Tₕₑ (° C.) | — | 186.7 | 208.7 |
| Surface hardness | HB | HB | HB |
| Rockwell hardness | 108 | 102 | 102 |
| Dynamic/Static friction | 0.37/0.32 | 0.48/0.40 | 0.40/0.34 |
| coefficient | | | |
| Heat distortion | 90 | 68 | 76 |
| temperature (° C.) | | | |
| Wear loss weight (mg) | 444.6 | 381.7 | 298.6 |

The wear-resistant polyester material according to an embodiment of the disclosure is modified by introducing the nucleating agent, the lubricant, and the antioxidant into the PET resin. The nucleating agent increases the crystallization and solidification rate and effectively improves the shrinkage rate of the PET material. The lubricant reduces the surface friction coefficient of the PET material to improve the wear resistance of the product. The antioxidant improves the heat resistance and processability of the PET material. Accordingly, the slow crystallization rate and insufficient heat resistance of the existing PET material are effectively improved, and the surface friction coefficient of the PET material is reduced to improve the wear resistance so that the wear-resistant polyester material of the disclosure is applicable to injection molding of products such as zippers, buckles, curtain parts, stationery, and cases to achieve the goal of use of one single material. In addition, besides PET virgin resin, the PET raw material used in an embodiment of the disclosure may be environmentally friendly recycled PET (PCR-PET), which has mechanical properties and surface smoothness equivalent to those of virgin resin. Therefore, the disclosure meets the needs of introducing recycled materials and is more in line with the trend of circular economy.

Although the disclosure has been described with reference to the embodiments above, the embodiments are not intended to limit the disclosure. People having ordinary knowledge in the art can make changes and modifications without departing from the spirit and scope of the disclosure. Therefore, the scope of protection of the disclosure should be defined by the following claims.

What is claimed is:

1. A wear-resistant polyester material, comprising:
a polyethylene terephthalate (PET) resin;
a nucleating agent;
a lubricant; and
an antioxidant.

2. The wear-resistant polyester material according to claim 1, wherein the PET resin is added in an amount of 99.35% by weight to 95% by weight, the nucleating agent is added in an amount of 0.5% by weight to 3% by weight, the lubricant is added in an amount of 0.05% by weight to 1% by weight, and the antioxidant is added in an amount of 0.1% by weight to 1% by weight based on a total weight of the wear-resistant polyester material.

3. The wear-resistant polyester material according to claim 1, wherein the nucleating agent is added in an amount of 1% by weight to 2% by weight based on a total weight of the wear-resistant polyester material.

4. The wear-resistant polyester material according to claim 1, wherein the PET resin comprises a virgin resin, a post consumer recycled (PCR) resin, or a combination thereof.

5. The wear-resistant polyester material according to claim 1, wherein the PET resin has an intrinsic viscosity of 0.58 to 0.92.

6. The wear-resistant polyester material according to claim 1, wherein the nucleating agent comprises an organic nucleating agent, an inorganic nucleating agent, or a blend thereof.

7. The wear-resistant polyester material according to claim 6, wherein the organic nucleating agent comprises organic sodium salts, and
the organic sodium salts comprise sodium benzoate, sodium stearate, sodium salt of montanic acids, or sodium salt of ethylene-methyl methacrylate copolymer.

8. The wear-resistant polyester material according to claim 6, wherein the inorganic nucleating agent comprises inorganic micro-nano powder, and
the inorganic micro-nano powder comprises talc, titanium dioxide, silicon dioxide, or calcium carbonate.

9. The wear-resistant polyester material according to claim 1, wherein the lubricant comprises stearates, polyethylene wax, siloxane modifier, or a fluorine-based resin.

10. The wear-resistant polyester material according to claim 1, wherein the antioxidant comprises a hindered phenolic antioxidant, a phenolic antioxidant, a mixed antioxidant, a phosphite-based antioxidant, a complex antioxidant, or a combination thereof.
